(19) United States
(12) Patent Application Publication
(10) Pub. No.: US 2024/0419767 A1
(43) Pub. Date: Dec. 19, 2024

(54) CONTAINER TREATMENT SYSTEM COMPRISING AT LEAST ONE CONTAINER TREATMENT MACHINE FOR TREATING CONTAINERS AND A CENTRAL RIGHTS ASSIGNMENT SYSTEM

(71) Applicant: KRONES AG, Neutraubling (DE)

(72) Inventors: Volker GRIMM, Neutraubling (DE); Johann SCHMIDBAUER, Neutraubling (DE); Jennifer SCHOEFFEL, Neutraubling (DE); Thomas BIRKENSEER, Neutraubling (DE)

(21) Appl. No.: 18/704,857

(22) PCT Filed: Oct. 27, 2022
(86) PCT No.: PCT/EP2022/080046

§ 371 Date: Apr. 25, 2024

(30) Foreign Application Priority Data
Oct. 27, 2021 (DE) 10 2021 127 963.1

(51) Int. Cl. G06F 21/31; B65B 57/00

(52) U.S. Cl. CPC G06F 21/31; B65B 57/00

(57) ABSTRACT

The invention relates to a container treatment system comprising at least one container treatment machine for treating containers and a central rights assignment system, the container treatment machine comprising a user interface for recognizing an identification element and for entering a user password, and the container treatment machine being designed to transmit identification data of a user to the central rights assignment system based on a recognized identification element and/or a recognized user password, the central rights assignment system being designed to transmit access data to the container treatment machine based on obtained identification data of a user, the access data defining group-based and/or user-based access rights for the container treatment machine, and the container treatment machine being designed to grant access rights to a user depending on obtained access data.

The present invention relates to a container treatment system comprising at least one container treatment machine for treating containers, and a central rights assignment system corresponding to independent claim 1, and a method for operating a container treatment system comprising the container treatment machine and a central rights assignment system corresponding to independent claim 8, and an identification element corresponding to independent claim 15.

### PRIOR ART

Container treatment systems with one or more container treatment machines are sufficiently known from the prior art. The container treatment machines include in particular machines that can produce containers from plastics such as PET, or other materials such as glass, or can process containers. The processing includes in particular filling and decorating (for example labeling or printing) parts of the container surface. Further container treatment machines are known that can inspect or package containers or further process them in another way.

In container treatment systems comprising a plurality of container treatment machines, it is customary for individual users to be granted access rights at each container treatment machine which depend, for example, on their qualification or a corresponding security release of the user. There are different access rights for maintenance personnel or administrators. The former may usually only access functions of a container treatment machine relevant to maintenance, wherein administrators usually have further access rights which, for example, also allow the setting and changing of operating parameters of individual or a plurality of container treatment machines.

It is known from the prior art that employees, such as the just described maintenance staff or administrators, can log onto a container treatment machine using a transponder or token or another identification element. On this container treatment machine, the corresponding user is then granted accesses to the functions of the container treatment machine based on his access rights stored in the container treatment machine.

If it is necessary to delete individual users or manage their rights, the staff responsible for this locally accesses the individual container treatment machines and changes the access rights for one or more persons on each container treatment machine.

While this procedure makes it possible in principle to control and modify the access rights of individual users on individual machines, it is susceptible to errors. Accordingly, transponders can be lost, whereby unauthorized persons may gain access to individual machines. Furthermore, it is necessary for all container treatment machines to be updated separately when the user rights of a specific user are changed in order to take the changed user rights into account. This can lead to errors if, for example, the required access rights are not changed on all machines or if a wrong user is inadvertently granted user rights that he should not actually have due to the entry of a wrong name or the like. In addition, this updating is time-consuming.

This poses security risks and can also make the reliable operation of a container treatment system more difficult since the updating of user rights can be time-consuming depending on the complexity of the container treatment system and the number of container treatment machines.

### OBJECT

Starting from the known prior art, the technical object to be achieved is therefore to specify a container treatment system which enables a flexible granting of access rights on the container treatment machines of the container treatment system, but at the same time allows safe and less error-prone operation of the container treatment system.

### ACHIEVEMENT

This object is achieved according to the invention by the container treatment system comprising at least one container treatment machine and a central rights assignment system according to claim 1, and the method for operating a container treatment machine of a container treatment system comprising the container treatment machine and a central rights allocation system according to claim 8, and the identification element according to claim 15. Advantageous embodiments of the invention are disclosed in the dependent claims.

The container treatment system according to the invention comprises at least one container treatment machine for treating containers and a central rights assignment system, wherein the container treatment machine comprises a user interface for recognizing an identification element and for entering a user password, and wherein the container treatment machine is designed to transmit identification data of a user to the central rights assignment system based on a recognized identification element and/or a recognized user password, wherein the central rights assignment system is designed to transmit access data to the container treatment machine based on received identification data of a user, wherein the access data defines group-based and/or user-based access rights for the container treatment machine, and wherein the container treatment machine is designed to grant access rights to a user depending on received access data.

The container treatment machine can be understood as any type of machine which enables a treatment of containers. These include container treatment machines known in particular in the beverage processing industry which produce containers from a raw material, such as PET, for example. These can be, for example, stretch blow molding machines or injection molding machines or can comprise them, wherein the latter first produce preforms from PET, and then the stretch blow molding machines form containers from the preforms using a stretch blow molding process, for example. However, the container treatment machines also include filling machines which fill containers, and cappers which enable a filled container to be closed. Container treatment machines should also include all inspection machines for inspecting containers (regardless of whether already filled or unfilled) and decorating machines for applying decorative elements to such containers, and further machines which, for example, enable inspecting or packaging the filled and closed and optionally decorated containers.

The container treatment system is therefore fundamentally not limited in terms of the type of container treatment machines and the number of container treatment machines.

Furthermore, in some embodiments, it can be provided that the container treatment system comprises a plurality of container treatment machines of the same type. The type of container treatment machine or the type of container treatment machines can be understood in particular in such a way that all container treatment machines which can carry out the same treatment of a container belong to the same type of container treatment machine. Thus, for example, blow molding machines can represent a type of container treatment machine, whereas cappers represents a different type of container treatment machine. Furthermore, it is also possible to distinguish between different versions of container treatment machines of the same type defined in this way. A first (sub)type of container treatment machines can therefore comprise, for example, a group of blow molding machines which can produce containers of a specific type (size, shape or the like) from preforms. A second group or a second (sub)type of container treatment machines can then be formed by a second number of blow molding machines which produce a different type of container (possibly also from other preforms). In principle, the types of container treatment machines can be distinguished according to technical specifications of the container treatment machines so that identical or substantially identical container treatment machines are associated with the same type.

While embodiments are preferably described in the field of container treatment systems, the invention is also applicable in connection with process engineering and storage management.

The central rights assignment system is preferably provided independently of each container treatment machine of the container treatment system (in particular physically and/or logically separate) and connected to the container treatment machines of the container treatment system via suitable data transfer lines, such as Ethernet connections or WLAN connections. It can preferably be provided that direct access to the central rights assignment system is not possible via a container treatment machine.

The identification element can preferably be designed as a physical identification element and comprise, for example, but not necessarily, an RFID chip or a transponder. These can advantageously be integrated into an identity card of the user. Furthermore, smartphones, smartwatches, generally devices which are equipped with an NFC chip, and all other devices which allow encoding and readout of the encoding can also be used as identification elements.

While a physical identification element on the one hand and a user password on the other hand are described for identification herein, one of these two options can also be replaced for identification by a biometric characteristic of a user, for example an iris scan, a fingerprint, facial recognition or the like.

In the following, group-based access rights should be understood to mean that these access rights will be or are assigned to specific groups of users who correspond, for example, in terms of the tasks performed by them or their qualifications. For example, a first group of users can be a group of people who are usually commissioned with maintenance tasks for container treatment machines. These can be associated with a group, wherein each member of the group can then have the same access rights.

User-based access rights should be understood as access rights that are assigned to a specific user, i.e., are individualized in this sense. It can be provided for a user to have both user-based access rights or to be assigned such rights, as well as for the user to be simultaneously assigned to a specific group of users, wherein the user-based access rights can go beyond the specific access rights or restrict the rights otherwise available to the same group of users. In particular, all access rights that are assigned to a user can be combined or stored in an associated user profile, wherein the user profile is preferably stored in the central rights assignment system or an associated memory. The user in turn can be stored as belonging to a specific group in the central rights assignment system. For this purpose, for example, an entry can be provided in the user profile, or the name of the user or another identification of the user can be stored in a data structure which identifies the members of the group to which the user belongs.

In addition to granting access rights, an individualization of the user interface can also be provided after logging onto a container treatment machine. Accordingly for example, an individualized user interface can appear after a certain user logs on. Furthermore, It is also possible that, depending on the assigned access rights, certain elements of the user interface such as menus or parts of menus, certain menu elements (such as interactive elements of a user interface) and/or certain information are not displayed on an existing user interface, or are displayed in addition to the existing elements of the user interface.

While a distinction is generally made here between user-specific access rights and group-specific access rights, it can also be provided that only group-specific access rights and no individualized (i.e., user-related) access rights are granted. This can be done with increased security by using an identification element and a user password, which in particular can improve security when accessing the container treatment machine, in particular for the granting of rights for users who belong to a plurality of groups.

A central assignment of access rights for each of the container treatment machines of a container treatment system is possible by the central rights assignment system in which the access data of the user are stored, wherein an individualization of user rights is nevertheless ensured. By means of this central assignment of rights, on the one hand the security of the entire container treatment system is increased, since access to the access rights assigned to the users is not possible on individual container treatment machines; on the other hand, at the same time a change in circumstances, such as the loss of an identification element or a change in access rights assigned to a user, can be quickly responded to. In this way, for example, the access by a user with his identification element to all container treatment machines can be blocked or adapted in a comparatively short time.

It can also be provided that the identification element is an active or a passive identification element.

Such identification elements as can actively transmit a signal to the user interface of the container treatment machine are to be understood as the active identification element. This can include a smartphone or tablet of a user, for example. Passive identification elements, on the other hand, should be understood as such identification elements that cannot actively transmit a signal. These include, for example, RFID chips, magnetically encoded tokens or barcodes or QR codes on or in ID cards or other identity cards that can be issued to operators.

The use of active or passive identification elements can be advantageous depending on the users and the tasks to be carried out by them on container treatment machines.

In one embodiment, it is provided that the central rights assignment system comprises a memory in which an identification element and/or a user password is assigned to a user, and group-based and/or user-based access rights for a group of users and/or at least one user can be entered by means of an input device of the central rights assignment system, and wherein the central rights assignment system is designed to assign the group-based and/or user-based access rights to the identification element and/or the user password.

A specific identification element and/or a user password can be assigned to a user, for example, in the form of an (encoded and/or encrypted) user profile. This user profile in turn can be accessed with this embodiment by the central rights assignment system, and the access rights of the user can therefore be set in a central manner.

This allows a reliable and efficient assignment of access rights both for groups of users as well as for individual users. In particular, it can be provided that the group-based access rights can be changed simultaneously in a setting for all users of the group in that the access rights assigned to the group are changed. Changes in the access rights that are to apply to all users of a group can therefore be carried out reliably and quickly, which can improve security during operation of the container system.

Furthermore, it can be provided that the container treatment machine is designed to grant access rights granted to a user for a preset session time when an identification element has been detected and a user password has been input, wherein the preset session time of the container treatment machine can optionally be sent by the central rights assignment system as part of the access data.

The preset session time can enable an operator to realize the tasks to be carried out on the container treatment machine as efficiently as possible without at least the renewed input of the user password being necessary during the preset session time. Alternatively or additionally, it can also be provided in this embodiment that, for example, to carry out certain activities on the container treatment machine, a renewed identification of the user with the aid of his identification element must at least also take place during the preset session time. This can be provided in particular for security-relevant inputs, for example a change in operating parameters.

In another embodiment, it is provided that the container treatment machine is designed to grant group-based access rights for a user on the basis of a detected identification element if no access data are received from the central rights assignment system.

In particular, it can be provided that exclusively group-based access rights are granted in this case. With this embodiment, operation of the container treatment machine can at least be maintained even if the data links to the central rights assignment system have failed. The group-based access rights can preferably be encoded by the identification element. In this embodiment, the group-based access rights, preferably only the group-based access rights, can be stored on the container treatment machine (for example on a central control unit of the container treatment machine, such as a computer) and can be retrieved depending on the recognized identification element. This embodiment ensures that at least the tasks to be carried out by a specific group of users with a container treatment machine can always be carried out.

Alternatively, it can be provided that, in the event that no access data are received from the central rights assignment system, access by the operator to the container treatment machine is blocked. In this case in some embodiments, access can then be enabled, for example, by logging on using a challenge/response procedure, for example through technical customer service. Alternatively or additionally, in such a case, access can also be granted via a user password and user name established for a specific container treatment machine, which are only communicated to persons with a particularly high level of trustworthiness, for example.

It can furthermore be provided that the container treatment system comprises at least two container treatment machines, wherein the central rights assignment system is provided separately from the at least two container treatment machines.

The use of a central rights assignment system according to the invention is particularly advantageous if more than one container treatment machine is part of the container treatment system since a central assignment of access rights then entails a great deal of time saved.

Furthermore, access rights for each of the at least two container treatment machines can be stored in the central rights assignment system.

In particular, different access rights for the same users can be stored for the two container treatment machines, so that, for example, a user has a first group of access rights on the first container treatment machine and possesses a second group of access rights on the second container treatment machine, wherein the second group of access rights is not identical to the first group. With this embodiment, with the aid of the central rights assignment system, even in complex container treatment systems comprising a plurality of container treatment machines, access rights for users can be stored individually and for each container treatment machine, which increases the flexibility in the assignment of access rights, while the security of the operation of the container treatment system is ensured.

The method according to the invention for operating a container treatment machine of a container treatment system comprising the container treatment machine and a central rights assignment system comprises:
detecting an identification element and/or an input user password in a user interface of the container treatment machine,
sending identification data of the user to the central rights assignment system,
sending access data from the central rights assignment system to the container treatment machine based on the received identification data of the user, wherein the access data define group-based and/or user-based access rights for the container treatment machine,
granting access rights for the user on the container treatment machine based on the received access data.

With this method, a central assignment of access rights for individual container treatment machines is possible, wherein at the same time, the access by operators to the individual container treatment machines is also provided in an efficient manner.

In one embodiment of the method, it is provided that the central rights assignment system comprises a memory in which an identification element and/or a user password is assigned to a user, and group-based and/or user-based access rights for a group of users and/or at least one user can be entered by means of an input device of the central rights assignment system, and wherein the central rights assignment system assigns the group-based and/or user-based access rights to the identification element and/or the user password.

A central processing of access rights for users is thereby possible.

Furthermore, it can be provided that the container treatment machine grants access rights granted to a user for a preset session time when an identification element has been detected and a user password has been entered, wherein the preset session time of the container treatment machine is optionally sent by the central rights assignment system as part of the access data.

This facilitates access to the container treatment machine, for example also during longer tasks to be carried out on the container treatment machine.

In one embodiment, the access rights granted to a user cannot be changed during the preset session time, regardless of whether the access rights assigned to the user are changed in the central rights assignment system during the preset session time, and/or the container treatment machine can be blocked for the user during the preset session time when the access rights assigned to the user are changed in the central rights assignment system in such a way that the user receives less access rights for the container treatment machine.

If the access rights are not changed during the preset session time, it is ensured that the respective user can reliably carry out the tasks assigned to him on the container treatment machine. Through the embodiment in which the container treatment machine is also locked for the user during the preset session time, it can be ensured that no unauthorized user receives access to the functions of the container treatment machine.

As an alternative to blocking the entire container treatment machine for the user, it can also be provided that, during the preset session time, only the rights are withdrawn from the user that were withdrawn from him due to a change in access rights in the central rights assignment system.

Furthermore, the container treatment machine can grant group-based access rights for a user on the basis of a detected identification element if no access data are received from the central rights assignment system.

This ensures that at least certain tasks can continue to be performed on the container treatment machine, even if access to the data of the central rights allocation system is not possible.

It can be provided that the container treatment system comprises at least two container treatment machines and that the central rights assignment system is provided separately from the at least two container treatment machines.

Furthermore, access rights for each of the at least two container treatment machines can be stored in the central rights assignment system.

According to the invention, an identification element with information contained on the identification element is also provided which, when it is recognized by a container treatment machine of a container treatment system according to one of the above embodiments, causes access rights to be granted by means of a method according to one of the preceding embodiments.

This identification element can be designed, for example, as a token or as RFID chip(s) or also as a QR code. Data can preferably be encoded in the identification element in such a way that a readout is only possible with difficulty, for example because the data are encrypted. The security of the container treatment system is thereby ensured even when such an identification element is lost.

### BRIEF DESCRIPTION OF THE FIGURES

FIG. 1 shows a container treatment system according to one embodiment.

FIG. 2 shows a flowchart of a method for operating a container treatment machine of a container treatment system according to one embodiment.

FIG. 3 shows another embodiment of a method for operating a container treatment machine.

FIG. 4 shows an embodiment of a user interface and an identification element.

### DETAILED DESCRIPTION

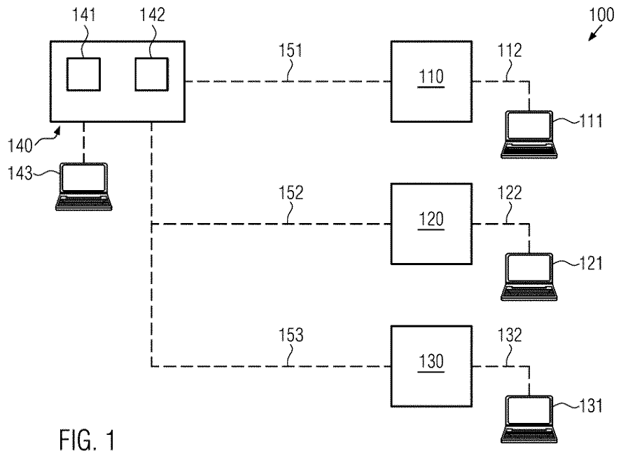

FIG. 1 shows an embodiment of a container treatment system 100 according to the invention. In FIG. 1, the container treatment system 100 comprises a series of container treatment machines 110, 120 and 130. However, the three container treatment machines shown here are not to be understood as limiting. The container treatment system can comprise any number of container treatment machines, in particular less than three, such as for example two or only one container treatment machine, but also more than three container treatment machines such as 4, 5 or 10 or 20 container treatment machines.

In particular, the container treatment machines can be organized into lines of more than 5, more than 10 or more than 15, in particular 15 to 20 container treatment machines. These lines or the container treatment machines of the individual lines do not all have to be stationed at the same location (such as in the same factory), but can also be distributed, for example, in different countries.

The container treatment machines 110 to 130 can be technically different so that they treat containers in different ways. For example, the container treatment machines 110-130 of the container treatment system 100 can be arranged successively in process directions for containers and perform successive treatment steps on containers. For example, the container treatment machine 110 can be designed as a stretch blow molding machine which forms containers from preforms. In the process direction of the containers, the container treatment machine 120 can be arranged downstream from the container treatment machine 110 and can, for example, be designed as a filler. This can fill a liquid product, such as a beverage, into the container. The container treatment machine 130, which can be designed, for example, as a capper, can then adjoin the container treatment machine 120 in the transport direction of the containers. This can provide the containers with a closure, for example a screw cap or a crown cork.

Further container treatment machines, such as decorating machines for applying print images or labels, or inspection machines, or packaging machines can also be part of the container treatment system 100. Furthermore, it can be provided that more than one container treatment machine of the same type of container treatment machine (e.g., stretch blow molding machine or filler) is provided in the container treatment system. For example, a stretch blow molding machine can be provided as part of the container treatment system, but also two fillers for filling with products. For example, they can fill different products into the respective containers fed to them.

With regard to the design of the container treatment machines, the container treatment system is not limited in terms of the number or the functions they can perform.

In the embodiment shown in FIG. 1, a user interface 111 or 121 or 131 is associated with each container treatment machine. Via this user interface, a user of the container treatment machine can interact with the (and preferably only with this) container treatment machine. The user interface can be designed, for example, as a customary control device of a container treatment machine, in particular as a computer or the like. The user interface can in particular comprise a keyboard and a display device (such as a screen), wherein entries by the user can be made via the keyboard, and information can be output on the display device.

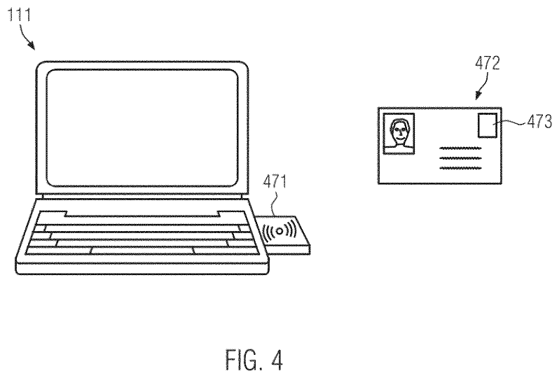

In addition, as described with reference to FIG. 4, a reading device, such as a QR scanner or an RFID scanner, can be associated with each user interface, by means of which a user can identify himself on the container treatment machine with an identification element, such as a QR code on an identity card of the user or an RFID token.

Furthermore, it can be provided that a user can enter a password assigned to him via the user interface 111, 121, 131 in order to additionally or alternatively identify himself on the respective container treatment machine.

For this purpose, the user interfaces are preferably connected via corresponding data links 112, 122 and 132 to the respective container treatment machine 110 to 130 for the purpose of data exchange. These data links (for example Ethernet cables or also WLAN connections) can preferably be bidirectional so that not only can data be entered into the container treatment machine via the user interface, but data from the container treatment machine can also be output to the user interface. This allows a user to control the container treatment machine. For example, operating parameters of the container treatment machine can thereby be changed, or protocols can be retrieved via the operation of the container treatment machine, for example when maintenance of the container treatment machine is necessary.

According to this embodiment, the container treatment system 100 further comprises a central rights assignment system 140. The central rights assignment system is preferably connected to each of the container treatment machines 110 to 130 via bidirectional data transmission devices 151 to 153. These data transmission devices 151 to 153 can be designed, for example, in the form of Ethernet connections or wireless connections, such as WLAN connections. However, they are not limited in this regard. The central rights assignment system 140 does not have to be provided in particular at the same location as the container treatment machines 110 to 130 of the container treatment system 100. It can also be arranged, for example, outside of factory buildings, for example in a company headquarters. The central rights assignment system 140 can accordingly have a suitable transceiver 142, which can be understood as part of the data transmission lines 151 to 153 or at least as connected thereto, in order to ensure the communication and in particular the data exchange with the container treatment machines 110 to 130 and the associated user interfaces 111 to 131.

The central rights assignment system preferably comprises a memory 141 which can be implemented, for example, as part of a server or a server architecture. According to the invention, data is stored in this memory that ensures an assignment of an identification element and/or a user password to a specific user. Furthermore, access rights for individual users or groups of users are stored in this memory or another memory logically or physically separate from this memory.

The central rights assignment system 140 can furthermore comprise an input device 143 with which the data stored in the memory 141 can be accessed, and in particular these data can also be changed so that, for example, access rights can be granted or withdrawn from a specific user, or a specific identification element, or a specific group of users, or new users or new groups can also be created.

With regard to the data stored in the memory 141 or generally in the central rights assignment system 140, several embodiments are conceivable.

It can therefore be provided that a series of groups is stored, and specific access rights are associated with each of the groups. Furthermore, individual access rights can be assigned to each user. These can be assigned to each individual user, for example independently of his affiliation with a specific group of users, and can also partially duplicate the rights already assigned by the group. Furthermore, it can be provided that individual users are associated with different groups. In this case, it can be provided that certain access rights are granted or denied to the user by the assignment of a user to a specific group.

A setting of access rights for users on two different levels is therefore possible. On the one hand, the access rights of entire groups of users can be changed. For example, a group of users can contain managerial personnel, who in principle are granted extensive access rights to container treatment machines. A second group of users can be associated with maintenance personnel who usually have less extensive access rights to the functions of individual machines.

A further assignment of access rights can take place, for example, on the level of individual container treatment machines or groups of container treatment machines. It can therefore be provided that certain groups of users are only granted certain access rights for certain types of container treatment machines, whereas with other types of container treatment machines, different access rights are granted to the same group of users.

In one embodiment, it can be provided that the association with a specific group of users and therefore the availability of corresponding access rights for a specific user is encoded via a suitable identification element, such as a token. The access rights to individual container treatment machines available to this user can, however, be encoded with his user password.

If a user identifies himself on a container treatment machine, such as the container treatment machine 110, with his identification element, this identifies the association with a particular group of users, and the user can be granted the corresponding access rights for this group. If the user also identifies himself with his password, he can be granted further access rights that depend on identification with the corresponding password, in addition to the access rights granted to him on the basis of association with the specific group identified by means of the identification element. However, this embodiment is not mandatory. In some embodiments, it can therefore be provided that no user-related access rights are provided. In this case, the additional identification with the user password serves to securely identify the user.

It can also be provided that the group-related access rights are also determined from the association of an operator with a plurality of groups. An operator can therefore be associated with a group of “maintenance personnel” (or generally group A) and “operator reserve” (or generally group B), which at least partially possess different access rights from one another. In one embodiment, the access rights of both groups can then be assigned to this operator. In some embodiments, in the event that the groups with which an operator is associated define mutually exclusive access rights (in group A, access to a particular function is allowed, in group B, access to that particular function is not allowed), it can be provided that the access rights assigned to the operator either allow access or deny access insofar as it concerns access to mutually exclusive access rights. This can either lead to increased operational security (in that access is denied to a function that is blocked for one of the groups) or simplify interaction with the machine (in that access is granted despite mutually exclusive access rights).

In some embodiments, it is provided that at least the specific user-related access rights or corresponding data which characterize these access rights are stored exclusively in the central rights assignment system 140, but not on the individual container treatment machines 110 to 130. The group-specific access rights, which can be encoded in particular by the identification elements available to the users, can be stored on the container treatment machines and additionally in the central rights assignment system. This allows the group-related access rights on the individual container treatment machines to be retrieved, even if an interruption of the data transmission lines 151 to 153 occurs, or if user-specific data cannot be transferred from the central rights assignment system to a specific container treatment machine for any other reason.

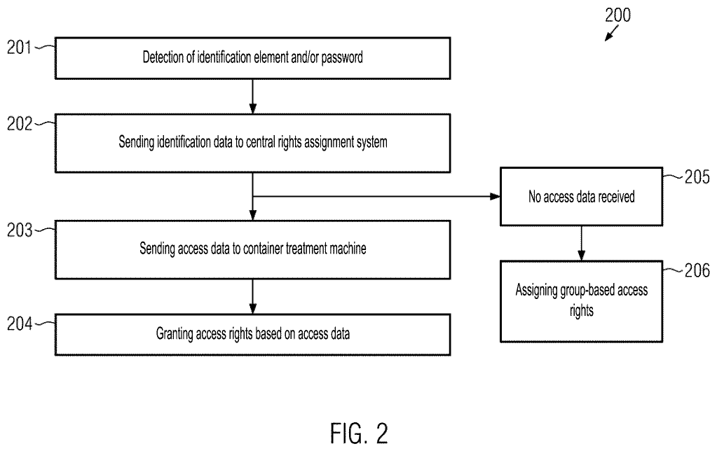

FIG. 2 shows a flowchart of a method according to one embodiment of the invention, as can be carried out, for example, by means of the embodiments of a container treatment system described in FIG. 1.

In this representation, the method 200 begins with step 201, in which an identification element and/or a password of a user is recognized on a specific container treatment machine, for example the container treatment machine 110 from FIG. 1. The recognition of the identification element can be ensured in step 201, for example by applying a token to a corresponding reading device. The password can be entered via the user interface 111, in particular a keyboard, already discussed with reference to FIG. 1.

Identification data that are at least indicative of the applied identification element and/or the input password can then be generated from the recognized identification element and/or the entered password. In step 202, these are then sent by the container treatment machine or the user interface associated therewith to the central rights allocation system. This can take place in the form of an encrypted data stream so that access to the identification data by third parties is prevented. For example, end-to-end encryption can be used for this purpose. Other encryption mechanisms are also conceivable here.

The central rights assignment system then processes the identification data that it has received in step 202 and derives access data therefrom by removing, for example, access rights based on the recognized identification element and/or the recognized password from the memory 141. This can be realized by identifying the user belonging to the identification element and the input password and the user profile and/or his group membership stored for this user.

In step 203, the central rights assignment system then sends access data to the container treatment machine. These access data preferably contain information that defines group-based and/or user-based access rights for the container treatment machine.

As already explained with regard to FIG. 1, the identification of a user with his identification element allows, in some embodiments, the identification of the group to which the user belongs. Based on this, corresponding access data can be transmitted from the central rights assignment system to the container treatment machine which define access rights that are available to the group of users to which the user belongs. User-based access rights and corresponding access data can be generated based on the entered password and are specific to this user.

In step 204, access to the functions of the container treatment machine can then be granted on the container treatment machine in accordance with the access rights defined by the access data. For a specific user, this can include, for example, that this user is given access to maintenance functions for the container treatment machine after corresponding identification. Depending on his access rights, another user can be granted access to the settings of the container treatment machine and, again depending on his access rights, be allowed to change the operating parameters of the container treatment machine.

This method, which utilizes the specific architecture of the container treatment system according to the embodiments described in connection with FIG. 1, ensures on the one hand that an operator of a container treatment machine only ever receives the access rights to which he is entitled on the basis of his identification with the identification element and the password. On the other hand, the centralized provision of the access data and the access rights on the central rights assignment system ensures an efficient and in particular fast changeover of access rights not only for groups of users, but also for individual users, which is advantageous in particular in container treatment systems comprising a plurality of container treatment machines.

FIG. 2 shows a second case of the method, wherein after the transmission of identification data to the central rights assignment system in step 202, the container treatment machine does not receive access data. This can be caused, for example, by a fault in the data transmission lines, such as for example an interruption of the WLAN connection or another failure of the data link.

In this case, the container treatment machine does not receive any or all of the access data required to securely guarantee all access by a user at the container treatment machine.

In some embodiments, it can then be provided that, in the event that no access data are received at the container treatment machine from the central rights assignment system in step 205, an assignment of access rights to the user is realized on the basis of his group membership.

As already described with reference to FIG. 1, an association of a user with a specific group of users and the associated access rights can be encoded by the identification element. In this case, the group-specific access rights that are available to each user who belongs to this group can be stored on the container treatment machine. In step 206, a user can therefore be granted at least the access at the container treatment machine within the scope of his group membership, even if his user-related data are not available on the container treatment machine.

However, this embodiment is not absolutely necessary, and in some embodiments it can also be provided that, if the container treatment machine does not receive any necessary access data from the central rights assignment system in response to the sending of the identification data to the central rights assignment system in step 202, the access to the container treatment machine is blocked.

In some embodiments, it can also be provided that the group-based access rights are only granted for certain groups if no access data are received. For example, access can be granted if the identification element indicates a group membership which allows access to a non-critical function of the container treatment machines, for example for maintenance purposes. Critical functions, such as changing and adjusting operating parameters, which is usually reserved for other groups of users, can, however, in some embodiments be denied if the identity of the user is not confirmed by the access data returned by the central rights assignment system.

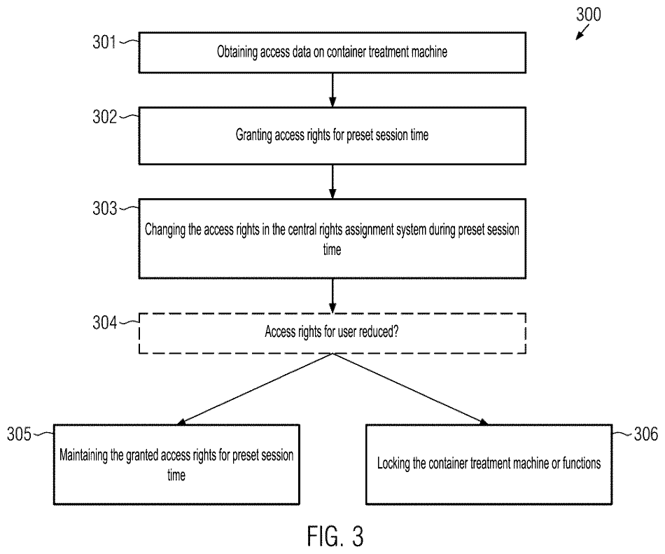

FIG. 3 shows another embodiment of a method that can be combined with the method according to FIG. 2. Accordingly, the method 300 begins in FIG. 3 with step 301, in which access data are received by the container treatment machine. This corresponds to the step 203 of the method described in FIG. 2, in which the access data are sent from the central rights assignment system to the container treatment machine.

These are then received at the container treatment machine in order to grant the access rights.

Instead of the general step 204 of FIG. 2, however, in the embodiment of FIG. 3, it is provided that the access rights are only granted for a preset session time, provided that the user has previously identified himself with his identification element and his password. This is shown schematically in step 302. The preset session time can be configured separately on each container treatment machine and can be, for example, one hour or two hours or four hours. Alternatively, the preset session time can also be sent to the container treatment machine as part of the access data, which allows a change in the preset session time by means of the central rights allocation system.

Together therewith, it can be provided that a change in this preset session time on the container treatment machine is not possible, which can prevent unauthorized accesses.

The granting of the access rights for the preset session time advantageously comprises at least that a user who has identified himself with his identification element and his password does not have to perform a renewed entry of the password at least during the preset session time. In some embodiments, it can also be provided that a renewed identification with the identification element is not required during the preset session time. In alternative embodiments, it can be provided that the user must also carry out an identification with the identification element during the preset session time, for example as soon as he calls a different function of the container treatment machine, or if a certain period of time which is less than the preset session time has elapsed.

During the preset session time, it can now happen that the access rights of a user or a group of users are changed in the central rights assignment system, while a user is working within the preset session time on a container treatment machine.

According to one embodiment, in such a case, it can be provided that the access rights granted to the user are maintained at least during the preset session time. This is shown in step 305 and can be granted without further checking by the container treatment machine.

Alternatively, it can be provided that the central rights assignment system, in the case in which group-related access rights or user-related access rights are changed, outputs information to all container treatment machines indicating that certain access rights of a group or a specific user have been changed.

In this case, a check can take place in step 304 of whether the access rights for the user who is working on a specific container treatment machine during the preset session time have been changed. This check can be made on the container treatment machine itself since it has the access data of the user during the preset session time, or they have been transferred to the container treatment machine.

If the comparison that the access rights of the user have been restricted (for example, because the general access rights of the group to which the user belongs have been restricted or because the user-specific access rights have been restricted), the container treatment machine or specific functions of the container treatment machine can be blocked in step 306. Further access to the container treatment machine or at least to specific functions of the container treatment machine is therefore also denied to the user even during the preset session time in order not to endanger the security of the operation of the container treatment machine. In this case, it can be provided that, even during the preset session time, certain functions to which a user initially had access based on his access data are blocked or reset to a default setting in order to prevent unauthorized persons from changing the operating parameters of the container treatment machine.

Blocking the entire container treatment machine or the entire access to the container treatment machine, or blocking individual functions of the container treatment machine can be dependent on the group membership or the original access rights of the user.

For example, if the user had administrator rights when the access data were received on the container treatment machine in step 301, and if these access rights have changed during the preset session time, it can be provided that all access by the user to the container treatment machine is blocked, since otherwise there may be a security risk to the operation of the container treatment machine if a user no longer provided with corresponding access rights has administrator rights to the container treatment machine.

If, on the other hand, the user is a member of a group of users who in any case only have restricted access to the container treatment machine, for example maintenance personnel, it can be provided that only certain functions that are no longer covered by the modified access data are blocked.

FIG. 4 shows an embodiment of a user interface 111 such as can be associated, for example, with a container treatment machine 110, corresponding to the embodiment described in FIG. 1. The embodiments described in FIG. 4 can be combined with the embodiments described with reference to FIGS. 1 to 3 and can also be applied to the further user interfaces 121 and 131 for the container treatment machines 120 and 130.

The user interface shown here can generally be designed as a laptop or computer. These embodiments are basically already known and require no further explanation.

In particular, a reading device or a reader which is designed to read information from an identification element 472 can be associated with the user interface. For example, the reader 471 can be a QR code reader. An RFID reader can also be provided as a reader 471.

In FIG. 4, an identification element 472 is also shown (independently of the user interface 111 and the reader 471). In the embodiment shown here, the identification element 472 is designed as an identity card. This ID card can be assigned to a user at the start of his employment, for example, and can contain his name and a picture of the user, but is not limited in this respect.

A QR code or an RFID chip can be integrated into the identification element, which can then be recognized and read by the user interface when placed on or brought close to the reader 471 of the user interface in order to extract the data relevant for identification. These data can then be output as part of the identification data to the central rights allocation system in order to enable identification of the user. Other embodiments of the identification element are also conceivable here. The identification element can therefore be provided as a token independently of the identity card shown in FIG. 4 or be designed separately from the identity card as another identity card or as a check card.

The embodiments based on RFID elements or QR codes can be understood as “passive” identification elements. As an alternative to these passive identification elements, active identification elements can also be provided. Active identification elements are such identification elements that can actively output an identification signal, for example by actuating a button on the identification element. These can be transponders, for example. Other active identification elements, such as a laptop or smartphone which is associated with the user can also be used. These can then have appropriately coded data that they can transmit to the user interface in order to identify the user.

As already described, identification with the identification element preferably only results in identification with regard to a group membership of a user. The user can also be individually identified by entering a password on the user interface. Alternatives are also conceivable for this purpose, such as for example a biometric identification of the user instead of entering a password. The user interface can accordingly have a camera or a fingerprint scanner. In this way, certain biometric characteristics of the user, such as his fingerprint, his face, his palm, his eyes, or the like, can be recognized, and with which an identification of the user can be realized analogously to an identification with a password.

1. A container treatment system comprising at least one container treatment machine for treating containers and a central rights assignment system, wherein the container treatment machine comprises a user interface for recognizing an identification element and for entering a user password, and wherein the container treatment machine is designed to transmit identification data of a user to the central rights assignment system based on a recognized identification element and/or a recognized user password, wherein the central rights assignment system is designed to transmit access data to the container treatment machine based on obtained identification data of a user, wherein the access data defines group-based and/or user-based access rights for the container treatment machine, and wherein the container treatment machine is designed to grant access rights to a user depending on obtained access data.

2. The container treatment system according to claim 1, wherein the identification element is an active or a passive identification element.

3. The container treatment system according to claim 1, wherein the central rights assignment system comprises a memory in which an identification element and/or a user password is assigned to a user, and group-based and/or user-based access rights for a group of users and/or at least one user can be entered by means of an input device of the central rights assignment system, and wherein the central rights assignment system is designed to assign the group-based and/or user-based access rights to the identification element and/or to the user password.

4. The container treatment system according to claim 1, wherein the container treatment machine is designed to grant access rights granted to a user for a preset session time when an identification element has been detected and a user password has been input.

5. The container treatment system according to claim 1, wherein the container treatment machine is designed to grant group-based access rights for a user on the basis of a detected identification element if no access data are received from the central rights assignment system.

6. The container treatment system according to claim 1, wherein the container treatment system comprises at least two container treatment machines, and wherein the central rights assignment system is provided separately from the at least two container treatment machines.

7. The container treatment system according to claim 6, wherein access rights for each of the at least two container treatment machines are stored in the central rights assignment system.

8. A method for operating a container treatment machine of a container treatment system comprising the container treatment machine and a central rights assignment system, wherein the method comprises:
recognizing an identification element and/or an input user password in a user interface of the container treatment machine
sending identification data of the user to the central rights assignment system
sending access data from the central rights assignment system to the container treatment machine based on the received identification data of the user, wherein the access data define group-based and/or user-based access rights for the container treatment machine; and
granting access rights for the user on the container treatment machine based on the received access data.

9. The method according to claim 8, wherein the central rights assignment system comprises a memory in which an identification element and/or a user password is assigned to a user, and group-based and/or user-based access rights for a group of users and/or at least one user can be entered by means of an input device of the central rights assignment system, and wherein the central rights assignment system assigns the group-based and/or user-based access rights to the identification element and/or to the user password.

10. The method according to claim 8, wherein the container treatment machine grants access rights granted to a user for a preset session time when an identification element has been detected and a user password has been input.

11. The method according to claim 10, wherein the access rights granted to a user cannot be changed during the preset session time, regardless of whether the access rights assigned to the user are changed in the central rights assignment system during the preset session time, and/or wherein the container treatment machine is blocked for the user during the preset session time when the access rights assigned to the user are changed in the central rights assignment system in such a way that the user receives less access rights for the container treatment machine.

12. The method according to claim 8, wherein the container treatment machine grants group-based access rights for a user on the basis of a detected identification element if no access data are received from the central rights assignment system.

13. The method according to claim 8, wherein the container treatment system comprises at least two container treatment machines, and wherein the central rights assignment system is provided separately from the at least two container treatment machines.

14. The method according to claim 13, wherein access rights for each of the at least two container treatment machines are stored in the central rights assignment system.

15. An identification element with information contained on the identification element which, when it is detected by a container treatment machine of a container treatment system according to claim 1 causes access rights to be granted by means of a method for operating the container treatment machine, wherein the method comprises:
recognizing an identification element and/or an input user password in a user interface of the container treatment machine
sending identification data of the user to the central rights assignment system
sending access data from the central rights assignment system to the container treatment machine based on the received identification data of the user, wherein the access data define group-based and/or user-based access rights for the container treatment machine; and
granting access rights for the user on the container treatment machine based on the received access data.

16. The container treatment system according to claim 4, wherein the preset session time of the container treatment machine can be sent by the central rights assignment system as part of the access data.

17. The method according to claim 10, wherein the preset session time of the container treatment machine is sent by the central rights assignment system as part of the access data.
